(19) United States
(12) Patent Application Publication
(10) Pub. No.: US 2014/0118314 A1
(43) Pub. Date: May 1, 2014

(54) Multiple-User Collaboration with a Smart Pen System

(71) Applicant: Livescribe Inc., Oakland, CA (US)

(72) Inventors: David Robert Black, Sunnyvale, CA (US); Brett Reed Halle, Pleasanton, CA (US); Andrew J. Van Schaack, Nashville, TN (US)

(73) Assignee: Livescribe Inc., Oakland, CA (US)

(21) Appl. No.: 14/062,566

(22) Filed: Oct. 24, 2013

Related U.S. Application Data
(60) Provisional application No. 61/719,298, filed on Oct. 26, 2012.

(51) Int. Cl. G09G 5/00; G06F 3/0354

(52) U.S. Cl. CPC G09G 5/006; G06F 3/03545
USPC 345/179

(57) ABSTRACT

A central device concurrently receives handwriting gestures from a plurality of smart pen devices. Each set of handwriting gestures includes a sequence of spatial positions of the corresponding smart pen device with respect to a writing surface. Representations of the handwriting gestures are displayed on a display screen, and the representations show relative timing between the different sets of handwriting gestures. In one embodiment, a portion of the received handwriting gestures is outputted for display.

### CROSS-REFERENCE TO RELATED APPLICATIONS

This application claims the benefit of U.S. Provisional Application No. 61/719,298, filed Oct. 26, 2012, the disclosure of which is incorporated herein by reference.

### BACKGROUND

This invention relates generally to pen-based computing systems, and more particularly to synchronizing recorded writing, audio, and digital content in a smart pen environment.

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). Additionally, some traditional smart pens include an embedded microphone that enable the smart pen to capture audio synchronously with capturing the writing gestures. The synchronized audio and gesture data can then be replayed. Smart pens can therefore provide an enriched note taking experience for users by providing both the convenience of operating in the paper domain and the functionality and flexibility associated with digital environments.

### SUMMARY

Embodiments of the invention provide a method and non-transitory computer-readable storage medium for concurrently receiving, by a central device, handwriting gestures from a plurality of smart pen devices. Each set of handwriting gestures includes a sequence of spatial positions of the corresponding smart pen device with respect to a writing surface. Representations of the handwriting gestures are displayed on a display screen, and the representations show relative timing between the different sets of handwriting gestures. In one embodiment, the displayed representations of the first and second handwriting gestures are overlaid on top of one another. In another embodiment, a portion of the received handwriting gestures is outputted for display.

In an embodiment, the central device also receives audio data from one or more of the smart pen devices, and replays a representation of the audio data. In some embodiments, the smart pen devices are identified by recognizing metadata from the smart pen devices, and the representations of the handwriting gestures from the identified smart pen devices are displayed in separate display windows on the display screen.

### BRIEF DESCRIPTION OF THE DRAWINGS

FIG. 1 is a schematic diagram of an embodiment of a smart-pen based computing environment.

FIG. 2 is a diagram of an embodiment of a smart pen device for use in a pen-based computing system.

FIG. 3 is a timeline diagram demonstrating an example of synchronized written, audio, and digital content data feeds captured by an embodiment of a smart pen device.

FIG. 4 is a block diagram of an embodiment of a method for sharing information between multiple users using different smart pen devices in a smart pen-based computing environment.

FIG. 5 illustrates an example of an interface for selecting data from multiple users to output to a shared screen.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview of a Pen-Based Computing Environment

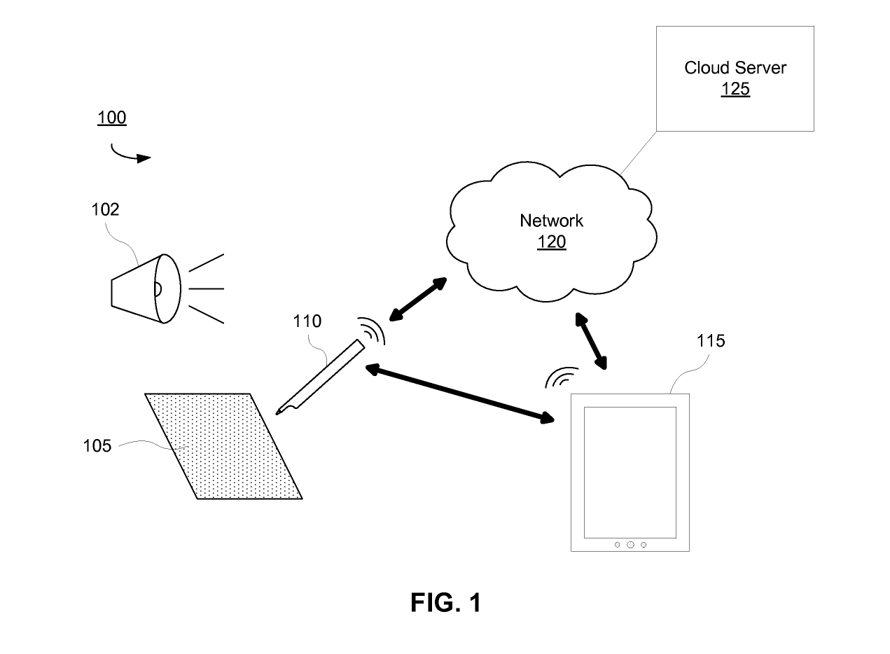

FIG. 1 illustrates an embodiment of a pen-based computing environment 100. The pen-based computing environment comprises an audio source 102, a writing surface 105, a smart pen 110, a computing device 115, a network 120, and a cloud server 125. In alternative embodiments, different or additional devices may be present such as, for example, additional smart pens 110, writing surfaces 105, and computing devices 115 (or one or more device may be absent).

The smart pen 110 is an electronic device that digitally captures interactions with the writing surface 105 (e.g., writing gestures and/or control inputs) and concurrently captures audio from an audio source 102. The smart pen 110 is communicatively coupled to the computing device 115 either directly or via the network 120. The captured writing gestures, control inputs, and/or audio may be transferred from the smart pen 110 to the computing device 115 (e.g., either in real-time or at a later time) for use with one or more applications executing on the computing device 115. Furthermore, digital data and/or control inputs may be communicated from the computing device 115 to the smart pen 110 (either in real-time or an offline process) for use with an application executing on the smart pen 110. The cloud server 125 provides remote storage and/or application services that can be utilized by the smart pen 110 and/or the computing device 115. The computing environment 100 thus enables a wide variety of applications that combine user interactions in both paper and digital domains.

In one embodiment, the smart pen 110 comprises a pen (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 110 on the writing surface 105 as the user would with a conventional pen. During the operation, the smart pen 110 digitally captures the writing gestures made on the writing surface 105 and stores electronic representations of the writing gestures. The captured writing gestures have both spatial components and a time component. For example, in one embodiment, the smart pen 110 captures position samples (e.g., coordinate information) of the smart pen 110 with respect to the writing surface 105 at various sample times and stores the captured position information together with the timing information of each sample. The captured writing gestures may furthermore include identifying information associated with the particular writing surface 105 such as, for example, identifying information of a particular page in a particular notebook so as to distinguish between data captured with different writing surfaces 105. In one embodiment, the smart pen 110 also captures other attributes of the writing gestures chosen by the user. For example, ink color may be selected by pressing a physical key on the smart pen 110, tapping a printed icon on the writing surface, selecting an icon on a computer display, etc. This ink information (color, line width, line style, etc.) may also be encoded in the captured data.

The smart pen 110 may additionally capture audio from the audio source 102 (e.g., ambient audio) concurrently with capturing the writing gestures. The smart pen 110 stores the captured audio data in synchronization with the captured writing gestures (i.e., the relative timing between the captured gestures and captured audio is preserved). Furthermore, the smart pen 110 may additionally capture digital content from the computing device 115 concurrently with capturing writing gestures and/or audio. The digital content may include, for example, user interactions with the computing device 115 or synchronization information (e.g., cue points) associated with time-based content (e.g., a video) being viewed on the computing device 115. The smart pen 110 stores the digital content synchronized in time with the captured writing gestures and/or the captured audio data (i.e., the relative timing information between the captured gestures, audio, and the digital content is preserved).

Synchronization may be assured in a variety of different ways. For example, in one embodiment a universal clock is used for synchronization between different devices. In another embodiment, local device-to-device synchronization may be performed between two or more devices. In another embodiment, external content can be combined with the initially captured data and synchronized to the content captured during a particular session.

In an alternative embodiment, the audio and/or digital content 115 may instead be captured by the computing device 115 instead of, or in addition to, being captured by the smart pen 110. Synchronization of the captured writing gestures, audio data, and/or digital data may be performed by the smart pen 110, the computing device 115, a remote server (e.g., the cloud server 125) or by a combination of devices. Furthermore, in an alternative embodiment, capturing of the writing gestures may be performed by the writing surface 105 instead of by the smart pen 110.

In one embodiment, the smart pen 110 is capable of outputting visual and/or audio information. The smart pen 110 may furthermore execute one or more software applications that control various outputs and operations of the smart pen 110 in response to different inputs.

In one embodiment, the smart pen 110 can furthermore detect text or other pre-printed content on the writing surface 105. For example, the smart pen 110 can tap on a particular word or image on the writing surface 105, and the smart pen 110 could then take some action in response to recognizing the content such as playing a sound or performing some other function. For example, the smart pen 110 could translate a word on the page by either displaying the translation on a screen or playing an audio recording of it (e.g., translating a Chinese character to an English word).

In one embodiment, the writing surface 105 comprises a sheet of paper (or any other suitable material that can be written upon) and is encoded with a pattern (e.g., a dot pattern) that can be read by the smart pen 110. The pattern is sufficiently unique to enable to smart pen 110 to determine its relative positioning (e.g., relative or absolute) with respect to the writing surface 105. In another embodiment, the writing surface 105 comprises electronic paper, or e-paper, or may comprise a display screen of an electronic device (e.g., a tablet). In these embodiments, the sensing may be performed entirely by the writing surface 105 or in conjunction with the smart pen 110. Movement of the smart pen 110 may be sensed, for example, via optical sensing of the smart pen device, via motion sensing of the smart pen device, via touch sensing of the writing surface 105, via acoustic sensing, via a fiducial marking, or other suitable means.

The network 120 enables communication between the smart pen 110, the computing device 115, and the cloud server 125. The network 120 enables the smart pen 110 to, for example, transfer captured digital content between the smart pen 110, the computing device 115, and/or the cloud server 125, communicate control signals between the smart pen 110, the computing device 115, and/or cloud server 125, and/or communicate various other data signals between the smart pen 110, the computing device 115, and/or cloud server 125 to enable various applications. The network 120 may include wireless communication protocols such as, for example, Bluetooth, Wifi, cellular networks, infrared communication, acoustic communication, or custom protocols, and/or may include wired communication protocols such as USB or Ethernet. Alternatively, or in addition, the smart pen 110 and computing device 115 may communicate directly via a wired or wireless connection without requiring the network 120.

The computing device 115 may comprise, for example, a tablet computing device, a mobile phone, a laptop or desktop computer, or other electronic device (e.g., another smart pen 110). The computing device 115 may execute one or more applications that can be used in conjunction with the smart pen 110. For example, content captured by the smart pen 110 may be transferred to the computing system 115 for storage, playback, editing, and/or further processing. Additionally, data and or control signals available on the computing device 115 may be transferred to the smart pen 110. Furthermore, applications executing concurrently on the smart pen 110 and the computing device 115 may enable a variety of different real-time interactions between the smart pen 110 and the computing device 115. For example, interactions between the smart pen 110 and the writing surface 105 may be used to provide input to an application executing on the computing device 115 (or vice versa).

In order to enable communication between the smart pen 110 and the computing device 115, the smart pen 110 and the computing device may establish a “pairing” with each other. The pairing allows the devices to recognize each other and to authorize data transfer between the two devices. Once paired, data and/or control signals may be transmitted between the smart pen 110 and the computing device 115 through wired or wireless means.

In one embodiment, both the smart pen 110 and the computing device 115 carry a TCP/IP network stack linked to their respective network adapters. The devices 110, 115 thus support communication using direct (TCP) and broadcast (UDP) sockets with applications executing on each of the smart pen 110 and the computing device 115 able to use these sockets to communicate.

Cloud server 125 comprises a remote computing system coupled to the smart pen 110 and/or the computing device 115 via the network 120. For example, in one embodiment, the cloud server 125 provides remote storage for data captured by the smart pen 110 and/or the computing device 115. Furthermore, data stored on the cloud server 125 can be accessed and used by the smart pen 110 and/or the computing device 115 in the context of various applications.

### Smart Pen System Overview

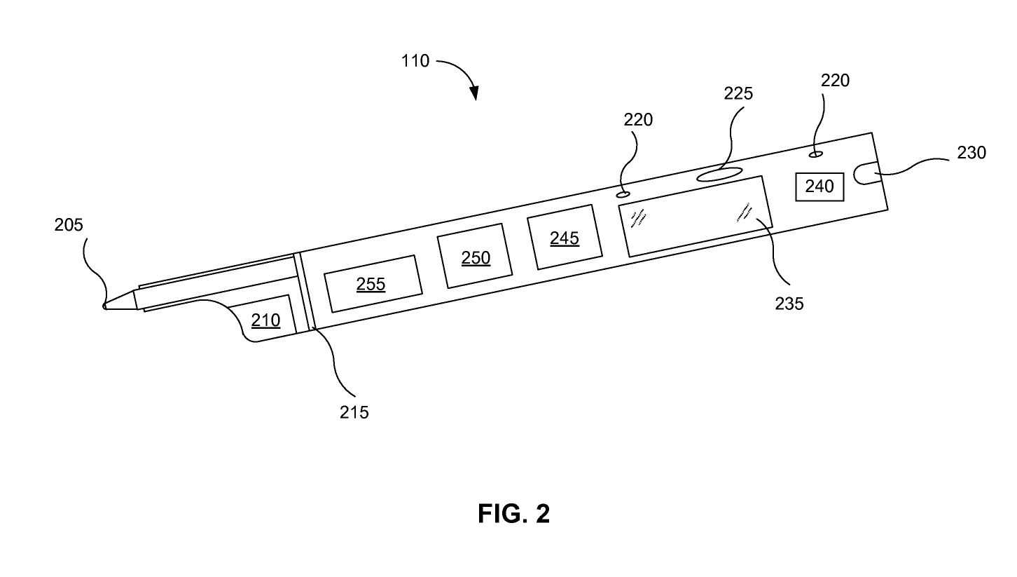

FIG. 2 illustrates an embodiment of the smart pen 110. In the illustrated embodiment, the smart pen 110 comprises a marker 205, an imaging system 210, a pen down sensor 215, one or more microphones 220, a speaker 225, an audio jack 230, a display 235, an I/O port 240, a processor 245, an onboard memory 250, and a battery 255. The smart pen 110 may also include buttons, such as a power button or an audio recording button, and/or status indicator lights. In alternative embodiments, the smart pen 110 may have fewer, additional, or different components than those illustrated in FIG. 2.

The marker 205 comprises any suitable marking mechanism, including any ink-based or graphite-based marking devices or any other devices that can be used for writing. The marker 205 is coupled to a pen down sensor 215, such as a pressure sensitive element. The pen down sensor 215 produces an output when the marker 205 is pressed against a surface, thereby detecting when the smart pen 110 is being used to write on a surface or to interact with controls or buttons (e.g., tapping) on the writing surface 105. In an alternative embodiment, a different type of “marking” sensor may be used to determine when the pen is making marks or interacting with the writing surface 110. For example, a pen up sensor may be used to determine when the smart pen 110 is not interacting with the writing surface 105. Alternative, the smart pen 110 may determine when the pattern on the writing surface 105 is in focus (based on, for example, a fast Fourier transform of a captured image), and accordingly determine when the smart pen is within range of the writing surface 105. In another alternative embodiment, the smart pen 110 can detect vibrations indicating when the pen is writing or interacting with controls on the writing surface 105.

The imaging system 210 comprises sufficient optics and sensors for imaging an area of a surface near the marker 205. The imaging system 210 may be used to capture handwriting and gestures made with the smart pen 110. For example, the imaging system 210 may include an infrared light source that illuminates a writing surface 105 in the general vicinity of the marker 205, where the writing surface 105 includes an encoded pattern. By processing the image of the encoded pattern, the smart pen 110 can determine where the marker 205 is in relation to the writing surface 105. An imaging array of the imaging system 210 then images the surface near the marker 205 and captures a portion of a coded pattern in its field of view.

In other embodiments of the smart pen 110, an appropriate alternative mechanism for capturing writing gestures may be used. For example, in one embodiment, position on the page is determined by using pre-printed marks, such as words or portions of a photo or other image. By correlating the detected marks to a digital version of the document, position of the smart pen 110 can be determined. For example, in one embodiment, the smart pen's position with respect to a printed newspaper can be determined by comparing the images captured by the imaging system 210 of the smart pen 110 with a cloud-based digital version of the newspaper. In this embodiment, the encoded pattern on the writing surface 105 is not necessarily needed because other content on the page can be used as reference points.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 105. This can be used to, for example, recognize handwriting or printed text, images, or controls on the writing surface 105. The imaging system 210 may further be used in combination with the pen down sensor 215 to determine when the marker 205 is touching the writing surface 105. For example, the smart pen 110 may sense when the user taps the marker 205 on a particular location of the writing surface 105.

The smart pen 110 furthermore comprises one or more microphones 220 for capturing audio. In an embodiment, the one or more microphones 220 are coupled to signal processing software executed by the processor 245, or by a signal processor (not shown), which removes noise created as the marker 205 moves across a writing surface and/or noise created as the smart pen 110 touches down to or lifts away from the writing surface. As explained above, the captured audio data may be stored in a manner that preserves the relative timing between the audio data and captured gestures.

The input/output (I/O) device 240 allows communication between the smart pen 110 and the network 120 and/or the computing device 115. The I/O device 240 may include a wired and/or a wireless communication interface such as, for example, a Bluetooth, Wi-Fi, infrared, or ultrasonic interface.

The speaker 225, audio jack 230, and display 235 are output devices that provide outputs to the user of the smart pen 110 for presentation of data. The audio jack 230 may be coupled to earphones so that a user may listen to the audio output without disturbing those around the user, unlike with a speaker 225. In one embodiment, the audio jack 230 can also serve as a microphone jack in the case of a binaural headset in which each earpiece includes both a speaker and microphone. The use of a binaural headset enables capture of more realistic audio because the microphones are positioned near the user's ears, thus capturing audio as the user would hear it in a room.

The display 235 may comprise any suitable display system for providing visual feedback, such as an organic light emitting diode (OLED) display, allowing the smart pen 110 to provide a visual output. In use, the smart pen 110 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 110, and the display 235 may display word phrases, static or dynamic images, or prompts as directed by such an application. In addition, the speaker 225 and audio jack 230 may also be used to play back audio data that has been recorded using the microphones 220. The smart pen 110 may also provide haptic feedback to the user. Haptic feedback could include, for example, a simple vibration notification, or more sophisticated motions of the smart pen 110 that provide the feeling of interacting with a virtual button or other printed/displayed controls. For example, tapping on a printed button could produce a “click” sound and the feeling that a button was pressed.

A processor 245, onboard memory 250 (e.g., a non-transitory computer-readable storage medium), and battery 255 (or any other suitable power source) enable computing functionalities to be performed at least in part on the smart pen 110. The processor 245 is coupled to the input and output devices and other components described above, thereby enabling applications running on the smart pen 110 to use those components. As a result, executable applications can be stored to a non-transitory computer-readable storage medium of the onboard memory 250 and executed by the processor 245 to carry out the various functions attributed to the smart pen 110 that are described herein. The memory 250 may furthermore store the recorded audio, handwriting, and digital content, either indefinitely or until offloaded from the smart pen 110 to a computing system 115 or cloud server 125.

In an embodiment, the processor 245 and onboard memory 250 include one or more executable applications supporting and enabling a menu structure and navigation through a file system or application menu, allowing launch of an application or of a functionality of an application. For example, navigation between menu items comprises an interaction between the user and the smart pen 110 involving spoken and/or written commands and/or gestures by the user and audio and/or visual feedback from the smart pen computing system. In an embodiment, pen commands can be activated using a “launch line.” For example, on dot paper, the user draws a horizontal line from right to left and then back over the first segment, at which time the pen prompts the user for a command. The user then prints (e.g., using block characters) above the line the desired command or menu to be accessed (e.g., Wi-Fi Settings, Playback Recording, etc.). Using integrated character recognition (ICR), the pen can convert the written gestures into text for command or data input. In alternative embodiments, a different type of gesture can be recognized to enable the launch line. Hence, the smart pen 110 may receive input to navigate the menu structure from a variety of modalities.

### Synchronization of Written, Audio and Digital Data Streams

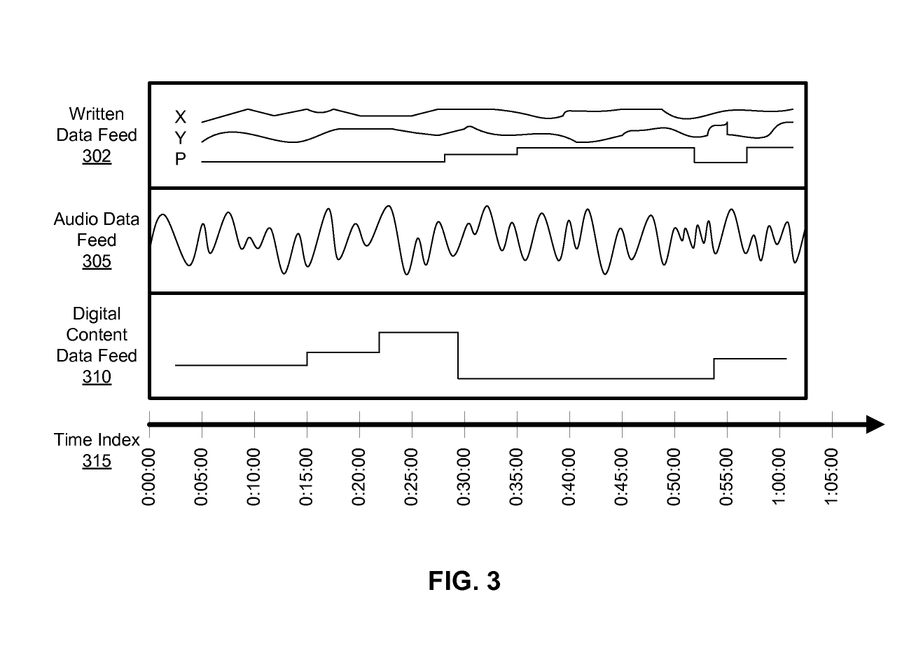

FIG. 3 illustrates an example of various data feeds that are present (and optionally captured) during operation of the smart pen 110 in the smart pen environment 100. For example, in one embodiment, a written data feed 300, an audio data feed 305, and a digital content data feed 315 are all synchronized to a common time index 315. The written data feed 302 represents, for example, a sequence of digital samples encoding coordinate information (e.g., “X” and “Y” coordinates) of the smart pen's position with respect to a particular writing surface 105. Additionally, in one embodiment, the coordinate information can include pen angle, pen rotation, pen velocity, pen acceleration, or other positional, angular, or motion characteristics of the smart pen 110. The writing surface 105 may change over time (e.g., when the user changes pages of a notebook or switches notebooks) and therefore identifying information for the writing surface is also captured (e.g., as page component “P”). The written data feed 302 may also include other information captured by the smart pen 110 that identifies whether or not the user is writing (e.g., pen up/pen down sensor information) or identifies other types of interactions with the smart pen 110.

The audio data feed 305 represents, for example, a sequence of digital audio samples captured at particular sample times. In some embodiments, the audio data feed 305 may include multiple audio signals (e.g., stereo audio data). The digital content data feed 310 represents, for example, a sequence of states associated with one or more applications executing on the computing device 115. For example, the digital content data feed 310 may comprise a sequence of digital samples that each represents the state of the computing device 115 at particular sample times. The state information could represent, for example, a particular portion of a digital document being displayed by the computing device 115 at a given time, a current playback frame of a video being played by the computing device 115, a set of inputs being stored by the computing device 115 at a given time, etc. The state of the computing device 115 may change over time based on user interactions with the computing device 115 and/or in response to commands or inputs from the written data feed 302 (e.g., gesture commands) or audio data feed 305 (e.g., voice commands). For example, the written data feed 302 may cause real-time updates to the state of the computing device 115 such as, for example, displaying the written data feed 302 in real-time as it is captured or changing a display of the computing device 115 based on an input represented by the captured gestures of the written data feed 302. While FIG. 3 provides one representative example, other embodiments may include fewer or additional data feeds (including data feeds of different types) than those illustrated.

As previously described, one or more of the data feeds 302, 305, 310 may be captured by the smart pen 110, the computing device 115, the cloud server 120 or a combination of devices in correlation with the time index 315. One or more of the data feeds 302, 305, 310 can then be replayed in synchronization. For example, the written data feed 302 may be replayed, for example, as a “movie” of the captured writing gestures on a display of the computing device 115 together with the audio data feed 305. Furthermore, the digital content data feed 310 may be replayed as a “movie” that transitions the computing device 115 between the sequence of previously recorded states according to the captured timing.

In another embodiment, the user can then interact with the recorded data in a variety of different ways. For example, in one embodiment, the user can interact with (e.g., tap) a particular location on the writing surface 105 corresponding to previously captured writing. The time location corresponding to when the writing at that particular location occurred can then be determined. Alternatively, a time location can be identified by using a slider navigation tool on the computing device 115 or by placing the computing device 115 is a state that is unique to a particular time location in the digital content data feed 210. The audio data feed 305, the digital content data feed 310, and or the written data feed may be re-played beginning at the identified time location. Additionally, the user may add to modify one or more of the data feeds 302, 305, 310 at an identified time location.

Multiple-User Collaboration within a Smart Pen-Based Computing Environment

In one embodiment, the smart pen system enables a group of individuals to conveniently share information in a common virtual workspace. For example, in an environment with multiple smart pens 110 (and corresponding writing surfaces 105), writing gestures captured on one or more of the individual smart pens 110 can be transmitted to a central device for display on a shared/virtual whiteboard and/or retained for future use. The gesture data displayed to the group can be filtered and/or adjusted to identify individual users (e.g. a different color per user). Furthermore, captured data from one or more of the smart pens may be restricted in some manner and then sent to individual displays for each of a subset of those users. Additionally, timing information present in the gesture data can be utilized to replay inputs by one or more users, demonstrating the order and speed in which the gesture data was originally captured.

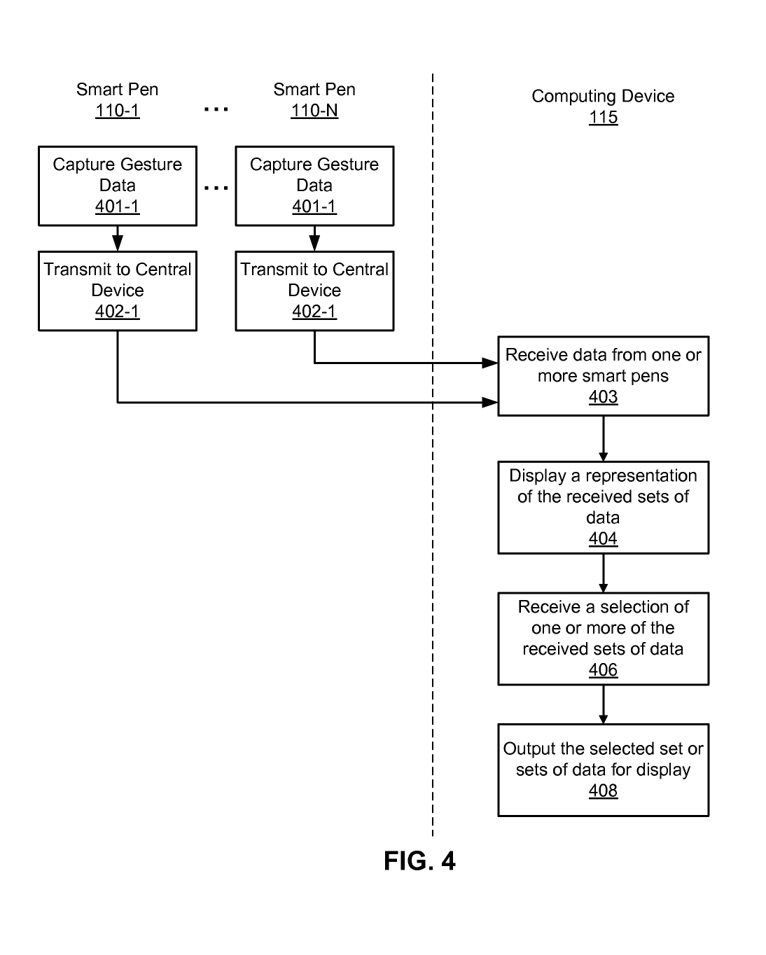

FIG. 4 illustrates an example of a method for sharing information between multiple smart pen users within a common virtual space in a smart pen-based computing environment. In one embodiment, the smart pen-based computing environment comprises multiple smart pens 110 (e.g., smart pens 110-1, . . . , 110-N), multiple writing surfaces 105, and optionally one or more computing devices 115. For example, the smart pen-based computing environment may comprise a classroom setting in which each student has a smart pen 110/writing surface 105 and an instructor has a computing device 115.

During the course of the collaborative session, the individual smart pens 110 (e.g., smart pens 110-1, . . . , 110-N) each captures 401 respective gesture data and transmits 402 the captured data to a central device (e.g., computing device 115). For example, in a classroom environment, the presenter may provide instructions for what or when the participants should be writing and the students' work is captured via their smart pens 110. The computing device 115 receives 403 the data transmitted from the one or more smart pens 110. Metadata may indicate which smart pen 110 or user corresponds to a particular set of data. For example, to distinguish between pens 110, a user-configurable label may be assigned to each pen 110, which may comprise, for example, a label that identifies the user (e.g., Dave's pen) or a generic label (e.g., classroom pen #23). Different pens 110 may also carry serial number information internally to uniquely identify each pen 110 independently of the configurable label.

The computing device 115 then displays 404 a representation of the received data. In one embodiment, the capturing 401, transmitting 402, receiving 403, and display 404 steps occur substantially in real-time such that the viewer of the computing device 115 can see the gestures from each smart pen 110 as they are being written. In the classroom setting, this allows, for example, an instructor to view the work of each student. In one embodiment, multiple sets of data can be viewed individually on the computing device 115, cataloged by user or pen 110. For example, the computing device 115 may include a split screen interface that shows content from different users on different portions of the screen. Alternatively, the computing device 115 may include an interface that enables the user to flip through different windows, each corresponding to data from a different smart pen user.

In an additional embodiment, multiple sets of data are displayed such that the captured writing gestures from multiple users are overlaid onto a single display surface. For example, an instructor may provide instructions to multiple students for an assignment in which each student has a writing surface 105 with a common dot pattern. Alternatively, different dot patterns may be used on different writing surfaces 105 and gestures from different students can be aligned in a post-processing step. After the students complete their work, the instructor can view the multiple sets of data from the students overlaid onto a single display surface, where the dot pattern allows for easy alignment of the captured writing gestures. This enables the instructor to see the commonalities or differences between different students' work. To identify individual users, the captured writing gestures can be assigned different colors in some embodiments. The users may also be filtered in other ways.

Furthermore, the multiple written data feeds 300, audio data feeds 305, and/or digital content data feeds 315 may be replayed simultaneously or successively on the computing device 115. This is beneficial, for example, to enable an instructor to gain insight into the thought process of the individual students because the instructor can see the order and timing of the work.

The computing device 115 may save the received data for future use. Alternatively, the data may be saved by the central server 125 and downloaded to the computing device 115 upon request. A user of the computing device 115 may also select one or more sets of received data to share with other participants. Here, the computing device 115 receives a selection of one or more of the received sets of data 406. This set or sets of data can then be outputted 408 for display. In some embodiments, the data may be outputted to individual displays associated with different participants. Alternately, the data may be outputted to a single shared display surface (e.g., a large screen or projector at the front of the room). In one embodiment, data may be filtered or restricted before being shared. For example, identifying information may be removed so that the data can be shared anonymously. Furthermore, other selected parts of the data may be hidden from the display or revealed in various circumstances. For example, the shared display surface may be configured to only show work associated with a particular question while hiding work related to other questions.

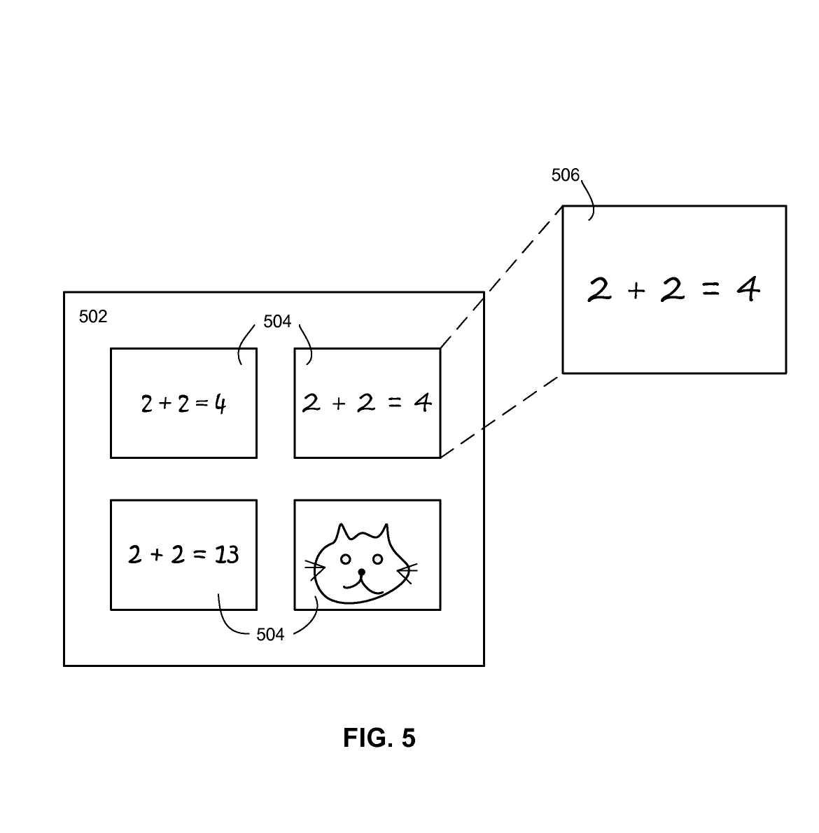

FIG. 5 illustrates an embodiment of a display 502 on a computing device 115 that presents an interface for viewing gesture data from multiple smart pens 110 and enables selection of one or more sets of data to share with other users. Here, multiple sets of gesture data 504 are received and displayed individually on the display 502 (e.g., from four different smart pens 110). A user controlling the computing device 115 selects one set of data to share with other users on a single display surface 506. The display surface 506 may be a larger screen, or it may be projected onto a wall, or it may be any surface suitable for display.

In this particular example, the different data 504 may represent work prepared by different students in a response to math problem presented by an instructor. In one embodiment, the display 502 enables the instructor to view the students' writing in real-time as they work out the problem. The instructor can then share one of the students' work with the class (e.g., in real-time or after completion). In another embodiment, the instructor could interact with the students' work on the display 502 with the smart pen 110. For example, the instructor could add new gesture data to the work.

In another embodiment, the sharing of digital content enables one individual's work to be printed out and shared with a different user. For example, an instructor may print out a solution to a particular problem and distribute it to one or more students while also causing a central device to transmit the digital data associated with the solution to the students' pens. The students can then interact with printed page using their individual pens. For example, a student can tap on a particular section and hear an audio explanation of the solution. Alternatively, the students can replay the gestures on a computing device 115 because the order and timing of the gestures may help the student understand how to work through the problem.

In other embodiments, the virtual workspace environment can enable collaborative application in other settings. For example, in business or engineering meetings, ideas from different participants can be shared to a common display or a problem can be collaboratively solved by multiple individuals.

### Additional Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
wirelessly receiving, by a central device, first handwriting gestures from a first smart pen device, the first handwriting gestures comprising a sequence of spatial positions of the first smart pen device with respect to a first writing surface;
wirelessly receiving, by the central device, second handwriting gestures from a second smart pen device, the second handwriting gestures comprising a sequence of spatial positions of the second smart pen device with respect to a second writing surface, at least a portion of the second handwriting gestures received concurrrently with the first handwriting gestures;
identifying the first and second smart pen devices by recognizing metadata received from the first and second smart pen devices; and
displaying representations of the first and second handwriting gestures concurrently on a display screen, the displaying comprising replaying the representations in substantially real-time as the first and second handwriting gestures are captured by the first and second smart pen devices.

2. The computer-implemented method of claim 1, further comprising:
receiving, by the central device, audio data from the first smart pen device, the audio data captured by an audio capture system of the first smart pen device; and
replaying a representation of the audio data from the central device.

3. The computer-implemented method of claim 2, wherein the audio data is temporally synchronized with corresponding handwriting gestures generated concurrently with the audio data.

4. The computer-implemented method of claim 1, further comprising selecting a portion of the received handwriting gestures, and outputting the portion of the received handwriting gestures for display.

5. The computer-implemented method of claim 1, further comprising filtering each displayed representation to identify the corresponding smart pen device.

6. The computer-implemented method of claim 1, further comprising:
displaying the representations of the first and second handwriting gestures from the identified smart pen devices in separate display windows on the display screen.

7. The computer-implemented method of claim 6, further comprising displaying each representation from each identified smart pen device in a different color.

8. The computer-implemented method of claim 1, wherein displaying representations of the first and second handwriting gestures concurrently on a display screen further comprises overlaying the displayed representations on top of one another.

9. The computer-implemented method of claim 1, further comprising:
receiving, at the central device, a selection of one of the first and second handwriting gestures; and
displaying the selected one of the first and second handwriting gestures on the display screen.

10. A non-transitory computer-readable storage medium storing computer executable instructions for displaying representations of handwriting gestures from multiple smart pens, the instructions when executed causing a processor to perform steps comprising:
wirelessly receiving, by a central device, first handwriting gestures from a first smart pen device, the first handwriting gestures comprising a sequence of spatial positions of the first smart pen device with respect to a first writing surface;
wirelessly receiving, by the central device, second handwriting gestures from a second smart pen device, the second handwriting gestures comprising a sequence of spatial positions of the second smart pen device with respect to a second writing surface, at least a portion of the second handwriting gestures received concurrrently with the first handwriting gestures;
identifying the first and second smart pen devices by recognizing metadata received from the first and second smart pen devices; and
displaying representations of the first and second handwriting gestures concurrently on a display screen, the displaying comprising replaying the representations in substantially real-time as the first and second handwriting gestures are captured by the first and second smart pen devices.

11. The non-transitory computer-readable storage medium of claim 10, the instructions when executed causing the processor to perform further steps comprising:
receiving, by the central device, audio data from the first smart pen device, the audio data captured by an audio capture system of the first smart pen device; and
replaying a representation of the audio data from the central device.

12. The non-transitory computer-readable storage medium of claim 11, wherein the audio data is temporally synchronized with corresponding handwriting gestures generated concurrently with the audio data.

13. The non-transitory computer-readable storage medium of claim 10, the instructions when executed causing the processor to perform further steps comprising selecting a portion of the received handwriting gestures, and outputting the portion of the received handwriting gestures for display.

14. The non-transitory computer-readable storage medium of claim 10, the instructions when executed causing the processor to perform further steps comprising filtering each displayed representation to identify the corresponding smart pen device.

15. The non-transitory computer-readable storage medium of claim 10, the instructions when executed causing the processor to perform further steps comprising:
displaying the representations of the first and second handwriting gestures from the identified smart pen devices in separate display windows on the display screen.

16. The non-transitory computer-readable storage medium of claim 15, the instructions when executed causing the processor to perform further steps comprising displaying each representation from each identified smart pen device in a different color.

17. The non-transitory computer-readable storage medium of claim 10, wherein displaying representations of the first and second handwriting gestures concurrently on a display screen further comprises overlaying the displayed representations on top of one another.

18. The non-transitory computer-readable storage medium of claim 10, the instructions when executed causing the processor to perform further steps comprising:
receiving, at the central device, a selection of one of the first and second handwriting gestures; and
displaying the selected one of the first and second handwriting gestures on the display screen.
